(19) United States
(12) Patent Application Publication
(10) Pub. No.: US 2011/0138594 A1
(43) Pub. Date: Jun. 16, 2011

(54) PLANT FOR BLOW-MOULDING PLASTIC CONTAINERS, PARTICULARLY BOTTLES

(75) Inventors: Maurizio Borgatti, Imola (IT); Massimo Morovingi, Imola (IT); Fiorenzo Parrinello, Medicina (IT); Emilio Re, Ancona (IT); Gabriele Stocchi, Parma (IT)

(73) Assignee: Sacmi Cooperativa Meccanici Imola Societa' Cooperativa, Imola (Bologna) (IT)

(21) Appl. No.: 13/055,752

(22) PCT Filed: Jul. 29, 2009
(86) PCT No.: PCT/IB2009/053295

§ 371 Date: Feb. 24, 2011

(30) Foreign Application Priority Data
Jul. 29, 2008 (IT) BO2008A000470

(51) Int. Cl. B23P 17/04; B29C 49/28

(52) U.S. Cl. 29/401.1; 425/183; 264/39

(57) ABSTRACT

A plant for blow-moulding plastic containers (2) from respective parisons (3) is equipped with a plurality of interchangeable moulding units (15), each having a certain number of cavities (19) for blow-moulding respective containers (2); and a line (9) for feeding the containers (2) from the moulding units (15) to a filling machine (10); the feed line (9) comprising a dispensing device (80) designed to space the containers (2) according to a spacing (P2) that is constant and independent of the number of moulding cavities (19) in the moulding units (15) mounted at a given time.

### TECHNICAL FIELD

This invention relates to a plant for blow-moulding plastic containers, particularly bottles.

### BACKGROUND ART

In the bottling industry, prior art plant for making plastic bottles comprises: a blow-moulding wheel mounted in such a way as to rotate about its longitudinal axis and equipped with a plurality of blow-moulding units, each of which is rotationally fed by the blow-moulding wheel about this axis and normally comprises one or two cavities for blow-moulding respective bottles; and a line for feeding the bottles from the blow-moulding wheel to the filling machine.

Since the spacing between bottles transferred from two-cavity blow-moulding units is different from the spacing between bottles transferred from single-cavity blow-moulding units, the feed line, and hence the filling machine, are selectively dimensioned to always work in conjunction either with two-cavity blow-moulding units or with single-cavity blow-moulding units, thus limiting the flexibility of this type of plant.

Alternatively, to enable use of a single feed line and a single filling machine with a blow-moulding wheel equipped with interchangeable blow-moulding units, the feed line and the filling machine are dimensioned to work in conjunction with two-cavity blow-moulding units and are then used only partially when the blow-moulding wheel is fitted with single-cavity blow-moulding units, thus significantly reducing the productivity of the plant.

Also known in the prior art, from patent document EP1350612, is a plant comprising a system of transfer carousels which interact with each other in such a way as to distribute the containers according to a spacing that remains constant upon variation of the number of moulding cavities of the blow-moulding line.

This system for distributing the containers according to a constant spacing is, however, particularly complex and expensive and is thus disadvantageous and not fully satisfactory as a technical solution.

### AIM OF THE INVENTION

This invention has for an aim to provide a blow-moulding plant for making plastic containers, particularly bottles, that is free of the above mentioned disadvantages.

In particular, the aim of the invention is to provide a plastic container blow-moulding plant equipped with a system which can distribute the containers according to a spacing that remains constant upon variation of the size of the bottles being made and which is at once simple and effective.

Accordingly, this invention provides a plant for blow-moulding plastic containers, particularly bottles, as described in the appended claims.

More specifically, this invention provides a blow-moulding plant for making plastic containers from respective parisons and comprising:

a blow-moulding line equipped with a plurality of moulding units having one or more cavities for blow-moulding respective containers and being interchangeable with other moulding units having a different number of moulding cavities;

a line for feeding the containers from the blow-moulding line to a filling machine equipped with a dispensing device designed to space the containers according to a spacing that is constant and independent of the number of moulding cavities of the moulding units mounted on the blow-moulding line.

According to the invention, the dispensing device comprises a screw feeder having a number of starts equal to the number of moulding cavities in the moulding units mounted on the blow-moulding line.

The invention also provides a method for changing over a plant that makes plastic containers from respective parisons in a blow-moulding line from making containers of one size to making containers of a different size.

The method comprises the following steps:

replacing the moulds of the blow-moulding line with other moulds having a different, predetermined number of moulding cavities;

adapting a line for feeding the containers from the blow-moulding line to a filling machine equipped with a dispensing device designed to space the containers according to a spacing that is constant and independent of the number of moulding cavities of the moulding units mounted on the blow-moulding line.

According to the invention, adapting the feed line comprises a step of replacing the dispensing device comprising a screw feeder having a number of starts equal to the number of moulding cavities in the moulding units mounted on the blow-moulding line with another screw feeder having a number of starts equal to said predetermined number.

### BRIEF DESCRIPTION OF THE DRAWINGS

The invention will now be described with reference to the accompanying drawings which illustrate a preferred, non-limiting embodiment of it and in which:

FIG. 1 is a schematic plan view, with some parts cut away for clarity, of a preferred embodiment of the plant according to the invention;

FIG. 2 is a schematic plan view, with some parts enlarged and others cut away for clarity, of a first detail of the plant of FIG. 1;

FIG. 3 is a schematic plan view, with some parts cut away for clarity, of a first detail from FIG. 2, shown in two different operating conditions;

FIG. 4 is a schematic plan view, with some parts cut away for clarity, of a detail from FIG. 3, shown in four different operating conditions;

FIG. 5 is a schematic side view, with some parts cut away for clarity, of a second detail from FIG. 2, shown in two different operating conditions;

FIG. 6 is a schematic side view, with some parts cut away for clarity, of a third detail from FIG. 2;

FIG. 7 is a schematic plan view, with some parts cut away for clarity, of a fourth detail from FIG. 2;

FIG. 8 is a schematic plan view, with some parts cut away for clarity, of a second detail of the plant of FIG. 1;

FIG. 9 is a schematic side view, with some parts cut away for clarity, of the detail of FIG. 8; and

FIG. 10 is a schematic plan view, with some parts cut away for clarity, of another embodiment of the detail of FIGS. 8 and 9;

### DETAILED DESCRIPTION OF THE PREFERRED EMBODIMENTS OF THE INVENTION

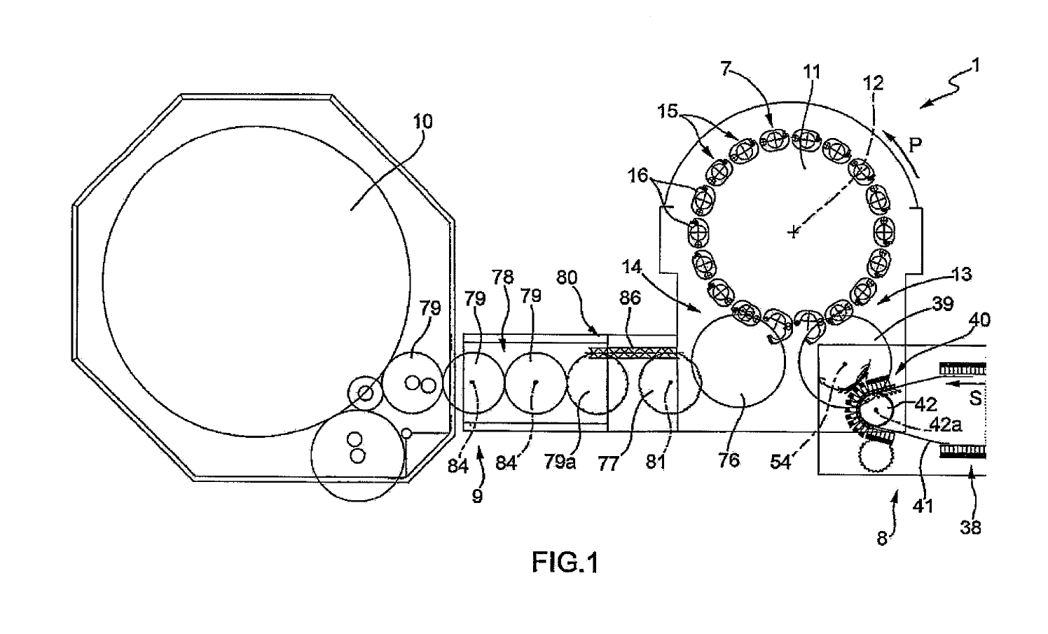

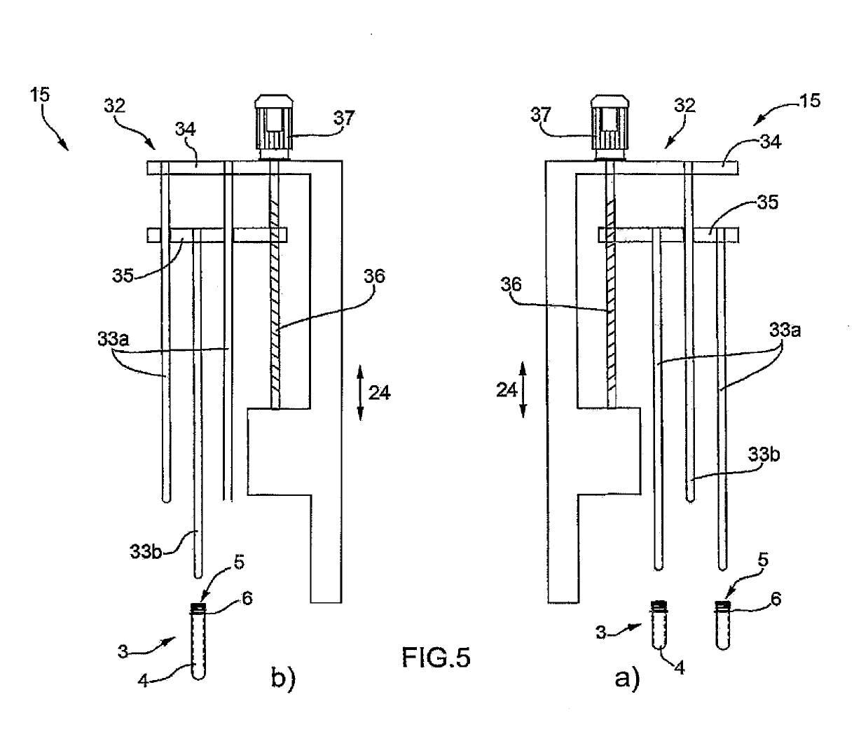

With reference to FIG. 1, the numeral 1 denotes in its entirety a plant for blow-moulding plastic containers, in this particular case, plastic bottles 2 (FIG. 9), from respective parisons 3 of known type (FIG. 5), each of which comprises an elongated cup-shaped body 4 having an externally threaded open end 5, and an annular neck 6 extending radially outwards from the outside surface of the body 4 itself.

The plant 1 comprises a blow-moulding machine 7 for blow-moulding the bottles 2, a line 8 for feeding the parisons 3 to the machine 7, and a line 9 for feeding the bottles 2 from the machine 7 to a customary filling machine 10.

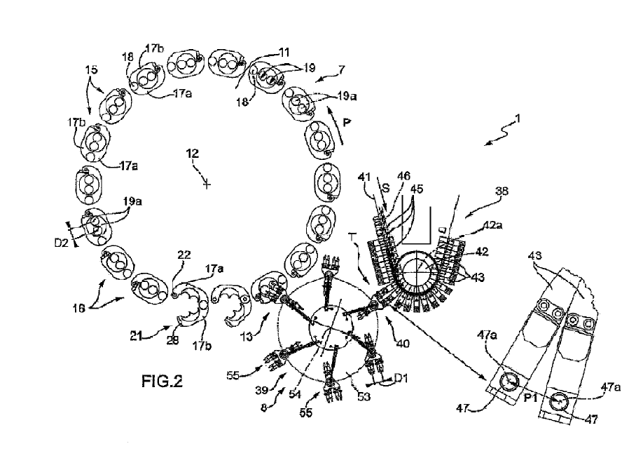

As illustrated in FIGS. 1 and 2, the machine 7 comprises a blow-moulding wheel 11 mounted in such a way as to rotate continuously (counterclockwise in FIGS. 1 and 2) about its longitudinal axis 12, which is substantially vertical and at right angles to the drawing plane of FIGS. 1 and 2. The wheel is connected to the lines 8 and 9 at a first and a second transfer station 13, 14, respectively, and is equipped with a plurality of moulding units 15 which are mounted round the edge of the wheel 11, are uniformly distributed around the axis 12 according to a predetermined spacing, and are advanced by the wheel 11 along a circular path P around the axis 12 and through the stations 13, 14.

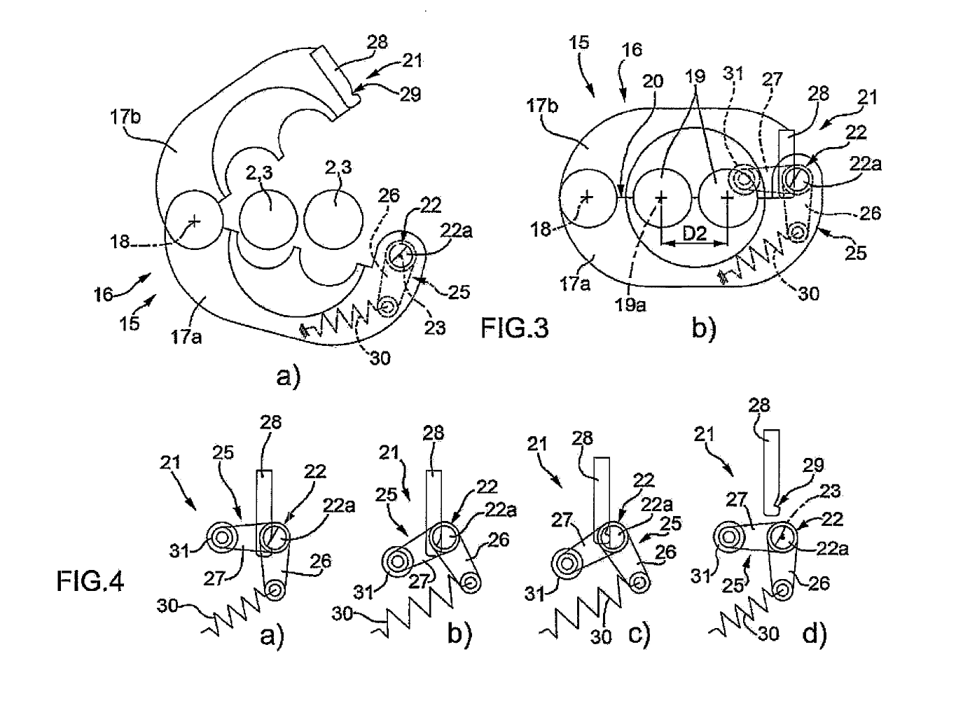

Each unit 15 comprises an interchangeable mould 16 comprising, in the embodiment illustrated in FIGS. 2 and 3, two half-moulds 17, each hinged to the wheel 11 to rotate relative to the wheel 11, under the action of a drive device (not illustrated) about a substantially vertical pivot axis 18 parallel to the axis 12 between a position for opening (FIG. 3a) and a position for closing (FIG. 3b) two moulding cavities 19, each having the shape of a bottle 2 and a longitudinal axis 19a parallel to the axis 18, being open to the outside at a hole at the top of it smaller in diameter than the neck 6 of a parison 3, and acting in conjunction with a pneumatic device of known type, not illustrated, designed to blow compressed air into the parison 3 inside the cavity 19 to mould the respective bottle 2.

The two half-moulds 17 are oriented in such a way that they are closed in a closing plane 20 substantially tangent to the path P and are locked in position by a locking device 21 comprising a cylindrical rod 22 having a longitudinal axis 23 parallel to the axis 12, extending through one of the two half-moulds 17 (hereinafter denoted by the reference 17a) along a vertical line 24 and being rotatably coupled to the half-mould 17a to rotate, relative to the half-mould 17a, about the axis 23 itself.

The rod 22 comprises at least one undercut portion 22a limited by a flat face parallel to the axis 23, and has keyed to it a rocker arm 25 mounted coaxially with the axis 23 and in turn comprising two arms 26, 27 which extend radially outwards from the axis 23 itself.

The device 21 also comprises a latch 28, elongated in shape, which extends transversally to the line 24, is fixed to the other half-mould 17 (hereinafter denoted by the reference 17b), and has an indent 29 formed on the latch 28 along the line 24 to receive and retain the portion 22a.

During the movement of the unit 15 from the station 13 to the station 14, the two half-moulds 17a, 17b are in their closed position, and a spring 30, interposed between the arm 26 and the half-mould 17a holds the rod 22 and the latch 28 in a normally locked position (FIG. 4a), where the portion 22a engages the indent 29 to prevent the mould 16 from opening.

During the movement of the unit 15 from the station 14 to the station 13, the rod 22 is moved against the action of the spring 30 to a released position (FIG. 4b), where the portion 22a disengages the indent 29 to enable the two half-moulds 17a, 17b to move (FIGS. 4c and 4d) to the open position by engaging a tappet roller 31 mounted on the arm 27 in a cam (not illustrated) designed to control the angular position of the rocker arm 25 around the axis 23.

In connection with the above, it should be noted that the two half-moulds 17a, 17b move relative to each other through different angles between the open and closed positions of the mould 16. More specifically, the angle of movement of the half-mould 17 located radially towards the outside of the path P, namely, the half-mould 17b, is greater than the angle of movement of the half-mould 17 located radially towards the inside of the path P, namely, the half-mould 17a.

With reference to FIG. 5, the unit 15 also comprises a stretching unit 32, mounted above the mould 16 and, in this particular embodiment, comprising three stretching rods 33 parallel to each other and to the line 24, two of which (hereinafter denoted by the reference 33a) are mounted in a position coaxial with the cavities 19, and the other (hereinafter denoted by the reference 33b) extends between the rods 33a.

The rods 33a, 33b are slidably coupled to both a mounting bracket 34 fixed to the wheel 11, and to a mounting plate 35 that is in turn coupled by a lead nut and screw mechanism to an output shaft 36 of an electric motor 37 fixed to the bracket 34, and are selectively locked on the bracket 34 or on the plate 35 along the line 24 by means of customary fastening screws not illustrated.

As illustrated in FIG. 5a, when the moulds 16, that is to say, the moulds with two moulding cavities 19, are mounted on the wheel 11, the rod 33b is locked axially on the bracket 34 and the rods 33a are locked axially on the plate 35 and are driven by the motor 37 along the line 24 between respective raised positions (FIG. 5a), where the rods 33a are positioned substantially outside the respective parisons 3, and respective lowered positions (not illustrated), where the rods 33a engage the respective parisons 3 in such a way as to stretch them axially along the line 24.

As illustrated in FIG. 5b, when the moulds 16 are replaced with moulds (not illustrated) having a single central moulding cavity each, for blow-moulding a bottle 2 of larger size, the rods 33a are locked axially on the bracket 34 and the rod 33b is locked axially on the plate 35 and is driven by the motor 37 along the line 24 between a raised position (FIG. 5b), where the rod 33b is positioned substantially outside the respective parison 3, and a lowered position (not illustrated), where the rod 33b engages the respective parison 3 in such a way as to stretch it axially along the line 24.

It may be inferred from the foregoing that changing the moulds of the blow-moulding units 15 does not necessitate changing the related stretching units 32 and that setup times are therefore relatively short.

In an embodiment that is not illustrated, when the wheel 11 mounts the moulds 16, that is to say, the moulds with two moulding cavities 19, the rod 33b must be removed and, when the moulds 16 are replaced with moulds (not illustrated) having a single central moulding cavity each, the rods 33a must be removed.

With reference to FIGS. 1 and 2, the feed line 8 comprises a heating device 38 for thermally conditioning the plastic material the parisons 3 are made of to a temperature greater than their glass transition temperature, and a transfer wheel 39 connected to the device 38 at a transfer station 40 and to the blow-moulding wheel 11 at the station 13.

The device 38 comprises an endless chain conveyor 41 that is trained around two pulleys 42 (only one of which is illustrated in FIGS. 1 and 2) rotatably mounted to turn about respective longitudinal axes 42a parallel to the line 24, extends through at least one customary oven not illustrated, and mounts a plurality of pick-up and transporting members 43 uniformly distributed along the conveyor 41 and advanced by the conveyor 41 itself along a looped path S.

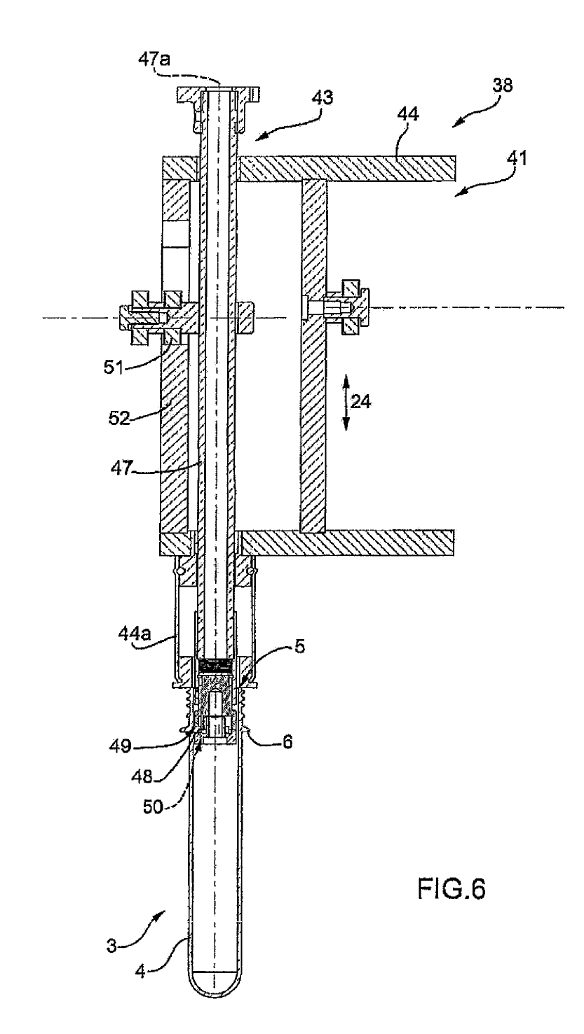

As illustrated in FIGS. 2 and 6, each member 43 comprises a tubular guide element 44 that is hooked up to the conveyor 41, extends along the line 24, is held in the correct position by engagement with a tappet roller 45 at a cam 46, and is slidably engaged by a respective pick-up rod 47 whose longitudinal axis 47a is parallel to the line 24.

The rod 47 is equipped with a plurality of balls 48 that are uniformly distributed around the axis 47a, are seated in respective housings 49 formed radially on a bottom end of the rod 47 protruding to the outside of the element 44, and protrude radially outwards from the respective housings 49 under the pushing action of respective springs 50 mounted inside the respective housings 49 transversally to the line 24.

The rod 47 is mobile under the pushing action of a tappet roller 51 placed in contact with a cam 52, along the line 24 between a lowered position (not illustrated), where the rod 47 extends inside the respective parison 3 to allow the balls 48 to grip the parison 3 under the pushing action of the respective springs 50, and a raised position (FIG. 6), where the rod 47 disengages the parison 3.

The member 43 further comprises an interchangeable limit stop block 44a that protrudes downwardly from the element 44 coaxially with the axis 47a to come into contact with the end 5 of the parison 3, is removably mounted on the element 44, and can be replaced according to the size and/or shape of the end 5 itself.

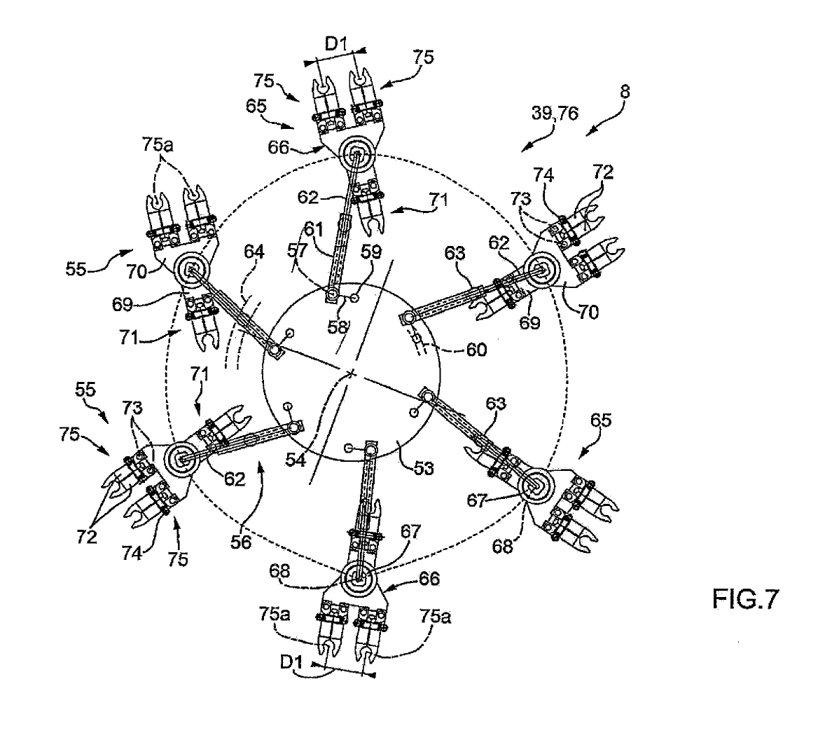

With reference to FIGS. 2 and 7, the wheel 39 comprises a drum 53 mounted to turn continuously about its substantially vertical longitudinal axis 54 parallel to the line 24, and a plurality of pick-up and transporting units 55 (in this particular embodiment six pick-up and transporting units 55) that are mounted along a peripheral edge of the drum 53, protrude radially outwards from the drum 53, and are advanced by the drum 53 itself around the axis 54 and through the stations 13 and 40.

Each unit 55 comprises a supporting rocker arm 56 that is hinged to the drum 53 to turn relative to the drum 53 itself about a pivot axis 57 substantially parallel to the line 24, and is equipped, at its first arm 58, with a tappet roller 59 in contact with a cam 60 designed to control the angular position of the rocker arm 56 around the axis 57 itself.

The rocker arm 56 also comprises a second, elongated arm 61 slidably engaged by a slider 62 that is equipped with a tappet roller 63 in contact with a cam 64 designed to control the position of the slider 62 along the arm 61, and supports at a free end of it, protruding to the outside of the arm 61 itself, a pick-up unit 65 comprising a rocker arm 66 hinged to the slider 62 to turn relative to the slider 62 and under the action, in this embodiment, of an electric motor 67 mounted on the slider 62, about a pivot axis 68 parallel to the line 24.

The rocker arm 66 has two arms 69, 70, opposite each other. The arm 69 mounts a pick-up element 71 having the shape of a fork and comprising two arms 72 which are mounted to oscillate about respective pivot axes 73 parallel to the line 24 between a position of releasing (not illustrated) and a position of clamping (FIG. 7) a respective parison 3, and which a spring 74 interposed between the arms 72 normally holds in the clamping position where the arms 72 grip the parison 3 above the neck 6.

The arm 70 mounts two pick-up elements 75 entirely equivalent to the element 71, parallel to each other and positioned side by side, having concavities facing away from the concavity of the element 71, and further having respective longitudinal axes 75a that are parallel to the line 24 and spaced from each other at a distance D1 equal to the distance D2 between the longitudinal axes 19a of the two moulding cavities 19 of one mould 16.

In connection with the above, it should be noted that:

according to the number of moulding cavities 19 in each mould 16, the pick-up elements 71, 75 are selectively oriented by the respective electric motors 67 about the respective axes 68 between respective operating positions where the pick-up elements 71, 75 are oriented towards the outside of the wheel 39, and respective rest positions where the pick-up elements 71, 75 are oriented towards the inside of the wheel 39;

by combining the movements of the rocker arms 56 about the respective axes 57 with the movements of the sliders 62 along the respective arms 61 and with the movements of the rocker arms 66 about the respective axes 68, the elements 71, 75 in their operating positions are kept substantially parallel to the path P at the station 13 and parallel to the path S at the station 40; and

the station 40 for transferring the parisons 3 from the conveyor 41 to the wheel 39 is positioned along a curved stretch T of the path S, preferably a stretch T around one of the pulleys 42, where the spacing P1 between the rods 47, and hence between the parisons 3, is equal to the distance D1 and hence to the distance D2, and different from the spacing between the rods 47 and, hence between the parisons 3, along the straight stretches of the path S.

From the above it may be inferred that the position of the station 40 and the shape of the wheel 39 make it possible to set up the plant 1 quickly and easily not only using moulds 16 with two moulding cavities 19 but also using moulds (not illustrated) with a single moulding cavity.

In another embodiment that is not illustrated, the rocker arms 66 are eliminated and replaced with interchangeable pick-up units, each of which is hinged to the respective slider 62 to oscillate about the respective axis 68 under the control of a tappet roller engaged in a cam, and which is equipped with one pick-up element 71 or two pick-up elements 75.

As illustrated in FIG. 1, the feed line 9 comprises: a transfer wheel 76 that is connected with the wheel 11 at the station 14, is entirely equivalent to the wheel 39 and will not therefore be described in further detail; a wheel 77 for extracting the bottles 2 from the pick-up elements 71, 75 of the transfer wheel 76; and a train 78 of feed wheels 79 connected to the wheel 77 through an interposed dispensing device 80 and designed to feed the bottles 2 to the filling machine 10.

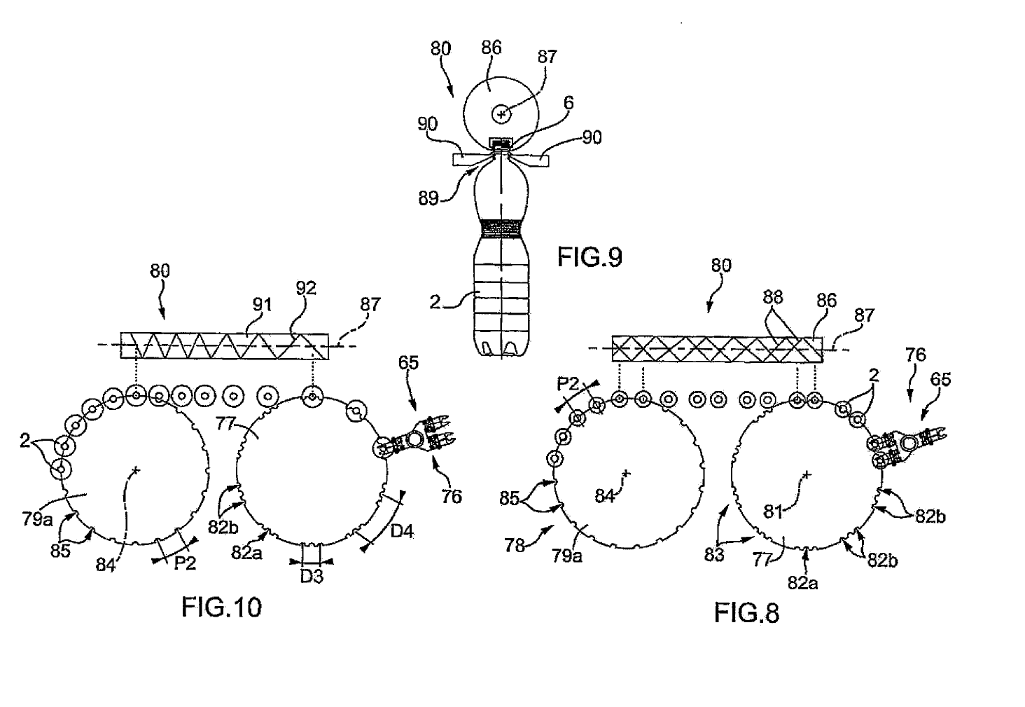

With reference to FIG. 8, the wheel 77 is mounted to rotate continuously about its longitudinal axis 81 parallel to the line 24, and is equipped with a plurality of semi-cylindrical pockets 82 formed along a peripheral edge of the wheel 77, open radially towards the outside, each designed to receive and retain a bottle 2, and divided into a plurality of groups 83 of pockets 82 equally spaced around the axis 81 and each comprising, in this particular embodiment, three pockets 82, of which one (hereinafter denoted by the reference 82a) is positioned between the other two (hereinafter denoted by the reference 82b) in turn positioned from each other at a distance D3 equal to the distances D1 and D2.

Each wheel 79 is mounted to rotate continuously about its longitudinal axis 84 parallel to the line 24, and is equipped with a plurality of semi-cylindrical pockets 85 formed along a peripheral edge of the wheel 79, open radially towards the outside, each designed to receive and retain a bottle 2, and uniformly distributed around the axis 84 according to a spacing P2 equal to the spacing of the dispensing nozzles (not illustrated) of the filling machine 10.

In this connection it should be noted that the spacing P2 is greater than the distance D3 and less than a distance D4 between two adjacent pockets 82a and that the distance D4 is also equal to the spacing between the moulds 16 on the blow-moulding wheel 11 and is therefore different from the distance D2.

As illustrated in FIGS. 8 and 9, the dispensing device 80 comprises, in this embodiment, a screw feeder 86, that is mounted to rotate continuously about its longitudinal, substantially horizontal axis 87 transversal to the line 24, extends between the wheel 77 and the infeed wheel 79 (hereinafter denoted by the reference 79a) of the train 78 of wheels 79, has two starts 88, that is to say, a number of starts equal to the number of moulding cavities 19 of one mould 16, is designed to engage the bottles 2 above the respective necks 6, and acts in conjunction with a guide channel 89 which extends parallel with the axis 87, which is slidably engaged by the bottles 2 and which is delimited by two side walls 90 designed to support the bottles 2 under the respective necks 6.

The embodiment illustrated in FIG. 10 differs from the one illustrated in the drawings described up to now only in that:

the moulds 16 with two moulding cavities 19 are eliminated and replaced with moulds (not illustrated) having only one moulding cavity;

the pick-up elements 71, 75 operate and come to rest at positions different from the above; and

the screw feeder 86 is eliminated and replaced with a screw feeder 91 having a single start 92.

In an embodiment that is not illustrated, the dispensing device 80 is eliminated and replaced with a customary, variable spacing transfer wheel.

The operation of the plant 1 will now be described with reference to the moulds 16 with two moulding cavities 19 and starting from an instant where the pick-up elements 71, 75 of the transfer wheels 39, 76 have been moved to their rest and operating positions, respectively.

The conveyor 41 feeds the parisons 3 one after the other to the station 40 where the spacing P1 of the parisons 3 is equal to the distance D1 between the pick-up elements 75 of each pick-up unit 65 of the wheel 39 so that each unit 65 can pick up a pair of parisons 3 from the conveyor 41.

Each pick-up unit 65 is then advanced by the wheel 39 through the transfer station 13 in step with a respective mould 16, whose half-moulds 17a, 17b are opened at the station 14 after the respective rod 22 has been moved to the released position in order to drop the parisons 3 into the respective moulding cavities 19.

At this point, the two half-moulds 17a, 17b are closed; the rod 22 is moved by the spring 30 to the latch 28 locked position; and the bottles 2 are moulded as the mould 16 advances from the station 13 to the station 14, where the mould 16 is opened to enable the pick-up elements 75 of one pick-up unit 65 of the transfer wheel 76 to extract the bottles 2 just moulded.

After that, the bottles 2 are first transferred by the wheel 76 into the pockets 82b of one group 83 of pockets 82 on the extraction wheel 77, are then advanced by the wheel 77 to the infeed end of the channel 89 and by the screw feeder 86 along the channel 89 and, lastly, are transferred by the screw feeder 86 into the pockets 85 of the wheel 79a according to the aforementioned spacing P2.

Operation of the plant 1 with moulds (not illustrated) having a single moulding cavity involves simply replacing the moulds 16 with the other moulds, moving the pick-up elements 71, 75 of the transfer wheels 39, 76 to their operating and rest positions, respectively, and replacing the screw feeder 86 with the screw feeder 91. It should be noted that, in this case, each bottle 2 is first transferred by the wheel 76 into the pocket 82a of one group 83 of pockets 82 on the extraction wheel 77, is then advanced by the wheel 77 to the infeed end of the channel 89 and by the screw feeder 91 along the channel 89 and, lastly is transferred by the screw feeder 91 into a pocket 85 of the wheel 79a according to the aforementioned spacing P2.

From the above it may be inferred that the position of the station 40, the shape of the transfer wheels 39, 76 and the presence of the screw feeders 86, 91 make it possible to set up the plant 1 quickly and easily not only using moulds 16 with two moulding cavities 19 but also using moulds (not illustrated) with a single moulding cavity, and to feed the same filling machine 10 and according to the same spacing P2 with bottles 2 of different sizes made in moulds 16 with two moulding cavities 19 as well as in moulds (not illustrated) with a single moulding cavity.

Lastly, it should be noted that, preferably, the assembly composed of the blow-moulding wheel 11, the transfer wheels 39, 76, the extraction wheel 77 and the screw feeders 86, 91 is driven by one drive motor (not illustrated), while the chain conveyor 41 and the train 78 of feed wheels 79 may be driven either by a single drive motor (not illustrated) or, alternatively, by separate motors (not illustrated) synchronized with each other. Indeed, since the use of moulds 16 with two moulding cavities 19 confers on the blow-moulding machine 7 a production capacity that is twice the production capacity conferred on the blow-moulding machine 7 by the use of moulds (not illustrated) with a single moulding cavity, the feed speeds of the conveyor 41 and of the train 78 of feed wheels 79 are selectively controlled in such a way that when the machine 7 mounts moulds 16 with two moulding cavities 19 the speeds are substantially twice the speeds imparted to the conveyor 41 and to the train 78 of feed wheels 79 when the machine 7 mounts moulds (not illustrated) with a single moulding cavity.

1) A blow-moulding plant for making plastic containers (2) from respective parisons (3), comprising:
a blow-moulding line (7) equipped with a plurality of moulding units (15) having one or more cavities (19) for blow-moulding respective containers (2) and being interchangeable with other moulding units (15) having a different number of moulding cavities (19);
a line (9) for feeding the containers (2) from the blow-moulding line (7) to a filling machine (10) equipped with a dispensing device (80) designed to space the containers (2) according to a spacing (P2) that is constant and independent of the number of moulding cavities (19) of the moulding units (15) mounted on the blow-moulding line (7),
wherein the dispensing device (80) comprises interchangeable screw feeders (86, 91) having a number of starts (88, 92) equal to the number of moulding cavities (19) in the moulding units (15) mounted on the blow-moulding line (7).

2) The plant according to claim 1, wherein each moulding unit (15) comprises at least two moulding cavities (19) having respective longitudinal axes (19a) located at a first distance (D2) from each other; the dispensing device (80) receiving at its infeed end an ordered succession of pairs of containers (2) spaced according to the first distance (D2) and dispensing at its outfeed end an ordered succession of containers (2) spaced according to the spacing (P2).

3) The plant according to claim 2, wherein the spacing (P2) is different from, and in particular, greater than, the first distance (D2).

4) The plant according to claim 2, wherein the moulding units (15) are spaced along the blow-moulding line (7) according to a further spacing that is different from the first distance (D2).

5) The plant according to claim 1, wherein each moulding unit (15) has a single moulding cavity (19); the dispensing device (80) receiving at its infeed end an ordered succession of pairs of containers (2) spaced according to a further spacing (D4) and dispensing at its outfeed end an ordered succession of containers (2) spaced according to the spacing (P2).

6) The plant according to claim 5, wherein the spacing (P2) is different from, and in particular, less than, the further spacing (D4).

7) The plant according to claim 1, wherein the dispensing device (80) comprises a variable spacing feed wheel equipped with a plurality of pick-up and transporting elements each designed to receive and retain a respective container (2), and able to be oriented relative to each other in such a way as to dispense the containers (2) according to the spacing (P2).

8) The plant according to claim 1, wherein the feed line (9) comprises:
a transfer wheel (76) interacting with the blow-moulding wheel (11) in such a way as to pick up the blow-moulded containers (2) from the respective moulding cavities (19);
an extraction wheel (77) coupled to the transfer wheel (76) for picking up the containers (2) and delivering them to the screw feeder (86).

9) The plant according to claim 8, wherein the extraction wheel (77) comprises a plurality of groups (83) of pockets (82), each of which is designed to receive and retain a respective container (2); each group (83) of pockets (82) comprising a number of pockets (82) at least equal to the maximum number of moulding cavities (19) in the moulding units (15) designed to be mounted on the blow-moulding line (7).

10) The plant according to claim 8, wherein the transfer wheel (76) comprises a plurality of pick-up and transporting members (69, 70), each of which is designed to receive and retain a number of containers (2) equal to the number of moulding cavities (19) in one of the moulding units (15) designed to be mounted on the blow-moulding line (7).

11) The plant according to claim 10, comprising a drive device (67) for selectively moving the pickup and transporting members (69, 70) between respective operating positions and respective rest positions according to the number of moulding cavities (19) in the moulding units (15) mounted on the blow-moulding line (7).

12) The plant according to claim 1, wherein the feed line (9) comprises a second transfer wheel (79a) connected with the screw feeder and having a plurality of further pockets (85) each designed to receive and retain a respective container (2) and distributed according to the spacing (P2).

13) The plant according to claim 1, wherein the spacing (P2) is equal to the spacing of a plurality of dispensing nozzles of the filling machine (10).

14) The plant according to claim 1, wherein:
the moulding units (15) have one cavity (19) for blow-moulding respective containers (2) and are interchangeable with other moulding units (15) having two moulding cavities (19);
the dispensing device (80) comprises a screw feeder (86) having two starts (88) and a screw feeder (91) having a single start (92).

15) A method for changing over a plant that makes plastic containers (2) from respective parisons (3) in a blow-moulding line (7) from making containers of one size to making containers of a different size, the method comprising the steps of:
replacing the moulds (16) of the blow-moulding line with other moulds having a different, predetermined number of moulding cavities (19);
adapting a line (9) for feeding the containers (2) from the blow-moulding line (7) to a filling machine (10) equipped with a dispensing device (80) designed to space the containers (2) according to a spacing (P2) that is constant and independent of the number of moulding cavities (19) of the moulding units (15) mounted on the blow-moulding line (7),
wherein adapting the feed line (9) comprises a step of replacing the dispensing device (80) comprising a screw feeder (86, 91) having a number of starts (88, 92) equal to the number of moulding cavities (19) in the moulding units (15) mounted on the blow-moulding line (7) with another screw feeder having a number of starts equal to said predetermined number.
